(19) United States
(12) Patent Application Publication
(10) Pub. No.: US 2020/0011827 A1
(43) Pub. Date: Jan. 9, 2020

(54) CAPACITIVE SENSOR AND PREPARATION METHOD THEREOF

(71) Applicants: South China Normal University, Guangzhou,Guangdong (CN); Shenzhen Guohua Optoelectronics Co., Ltd., Shenzhen, Guangdong (CN); Academy of Shenzhen Guohua Optoelectronics, Shenzhen, Guangdong (CN)

(72) Inventors: Guofu ZHOU, Shenzhen, Guangdong (CN); Rui ZHOU, Guangzhou, Guangdong (CN); Jun LI, Guangzhou, Guangdong (CN); Qianling YE, Guangzhou, Guangdong (CN); Nicolaas De ROOIJ, Shenzhen, Guangdong (CN)

(21) Appl. No.: 16/491,122

(22) PCT Filed: Dec. 12, 2017
(86) PCT No.: PCT/CN2017/115688

§ 371 Date: Sep. 4, 2019

(30) Foreign Application Priority Data
Sep. 12, 2017 (CN) 201710821152.1

(51) Int. Cl. G01N 27/22

(52) U.S. Cl. CPC G01N 27/226; G01N 2027/222; G01N 27/223; G01N 27/221

(57) ABSTRACT

A capacitive sensor and a preparation method thereof are disclosed. By disposing differential positive-negative electrode pair that include a first positive-negative electrode pair (4, 5, 6) and a second positive-negative electrode pair (11, 12, 13), and disposing a functional material layer (7, 8, 9) on the first positive-negative electrode pair (4, 5, 6), differential measurement is achieved, and thus the accuracy and sensitivity of the capacitive sensor are improved.

### TECHNICAL FIELD

The present disclosure relates to the field of sensors, and in particularly, to a capacitive sensor and a preparation method thereof.

### BACKGROUND

As one of the three technical cornerstones of modern information technology, sensors occupy an extremely important position in the national economic construction. In recent years, with the rapid development of smart terminals, wearable electronic devices such as smart phones and smart watches have placed higher demands on integrated multi-functional sensors.

A capacitive sensor is a conversion plant that uses various types of capacitors as sensing elements and converts a measured physical quantity or mechanical quantity into a capacitance change, and is actually a capacitor with variable parameters. In some examples, an ambient gas sensor can detect and test some gases in the environment, showing great potential for application in the field of environmental protection. Some ambient gas sensors are based on a flexible substrate, however, the influences of the flexible substrate on capacitive noises of the sensor may not be eliminated, resulting in a large deviation of the sensor test data.

### SUMMARY

For solving the above technical problems, the present disclosure aims at providing a capacitive sensor with high precision and a preparation method thereof.

The technical solution of the present disclosure is as follows: a capacitive sensor comprises a substrate, and further comprises differential positive-negative electrode pair disposed on the substrate, wherein the differential positive-negative electrode pair comprises a first positive-negative electrode pair and a second positive-negative electrode pair, and a functional material layer is disposed on the first positive-negative electrode pair.

Further, a temperature compensation layer is disposed between the substrate and the differential positive-negative electrode pair.

Further, the temperature compensation layer comprises a heating electrode and a first insulating layer, the heating electrode is disposed above the substrate, and the first insulating layer is covered above the heating electrode.

Further, the capacitive sensor further comprises a second insulating layer covered above the first positive-negative electrode pair.

Further, both the first positive-negative electrode pair and the second positive-negative electrode pair are interdigitated positive-negative electrode pairs.

Further, the functional material layer is a moisture-sensitive functional material layer, an ammonia-sensitive functional material layer, or a carbon monoxide-sensitive functional material layer.

Further, the functional material layer has a thickness of 1 μm to 3 μm.

Another technical solution of the present disclosure is as follows: a preparation method for a capacitive sensor comprises:

cleaning a substrate and drying the substrate to impurity-free;

preparing differential positive-negative electrode pair on the substrate, the differential positive-negative electrode pair comprises a first positive-negative electrode pair and a second positive-negative electrode pair; and

preparing a functional material layer on the first positive-negative electrode pair.

Further, a functional material is coated on the first positive-negative electrode pair by screen printing, slit coating or inkjet printing to prepare the functional material layer.

Further, a conducting material is coated on the substrate by screen printing, slit coating or inkjet printing to prepare the differential positive-negative electrode pair.

Further, both the first positive-negative electrode pair and the second positive-negative electrode pair are interdigitated positive-negative electrode pairs.

Further, the functional material layer is a moisture-sensitive functional material layer, an ammonia-sensitive functional material layer, or a carbon monoxide-sensitive functional material layer.

Further, the functional material layer has a thickness of 1 μm to 3 μm.

The present disclosure has the beneficial effects as follows.

By disposing the differential positive-negative electrode pair that comprise the first positive-negative electrode pair and the second positive-negative electrode pair, and disposing the functional material layer on the first positive-negative electrode pair, differential measurement is achieved by the present disclosure, and thus the accuracy and sensitivity of the capacitive sensor are improved.

### BRIEF DESCRIPTION OF THE DRAWINGS

The specific embodiments of the present disclosure will be further described hereinafter in detail with reference to the drawings.

FIG. 1 is a top view of a specific embodiment of a capacitive sensor according to the present disclosure;

FIG. 2 is a left view of a specific embodiment of a capacitive sensor according to the present disclosure;

FIG. 3 is a schematic diagram of a specific embodiment of a heating electrode in a capacitive sensor according to the present disclosure;

FIG. 4 is a schematic diagram of a specific embodiment of differential positive-negative electrode pair in a capacitive sensor according to the present disclosure; and

FIG. 5 is a flow chart of a specific embodiment of a preparation method for a capacitive sensor according to the present disclosure.

### DETAILED DESCRIPTION

It should be noted that, in case of no conflict, the embodiments in the present application and the features in the embodiments may be combined with each other.

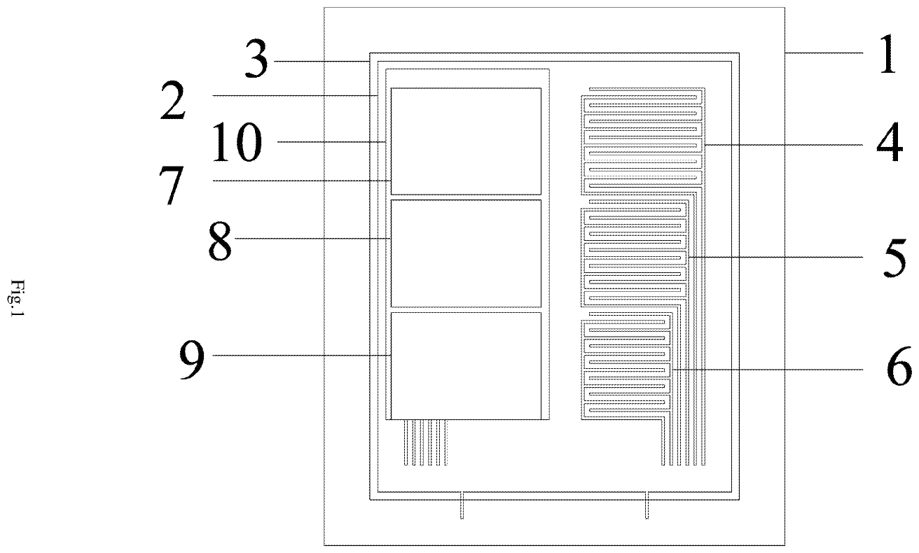

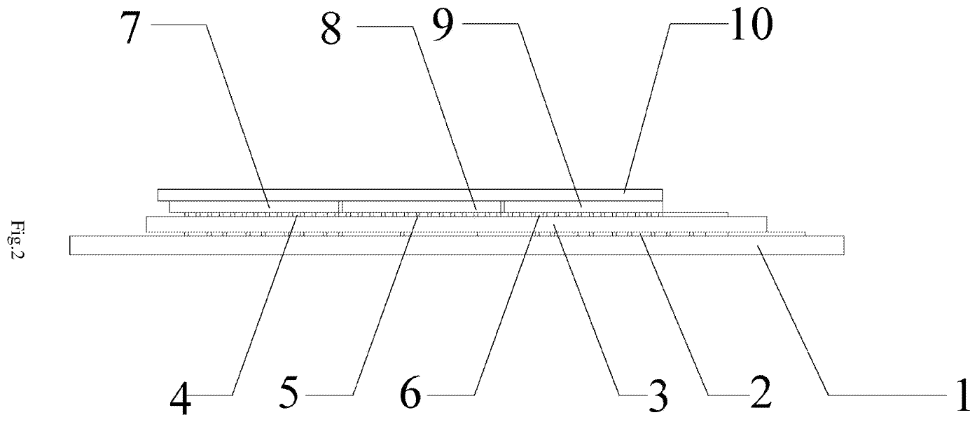

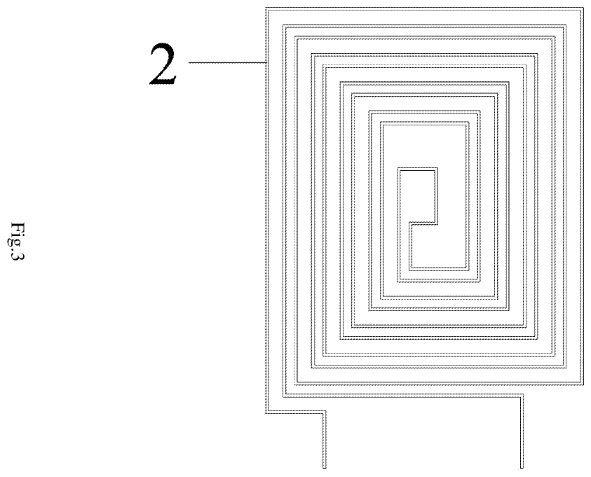

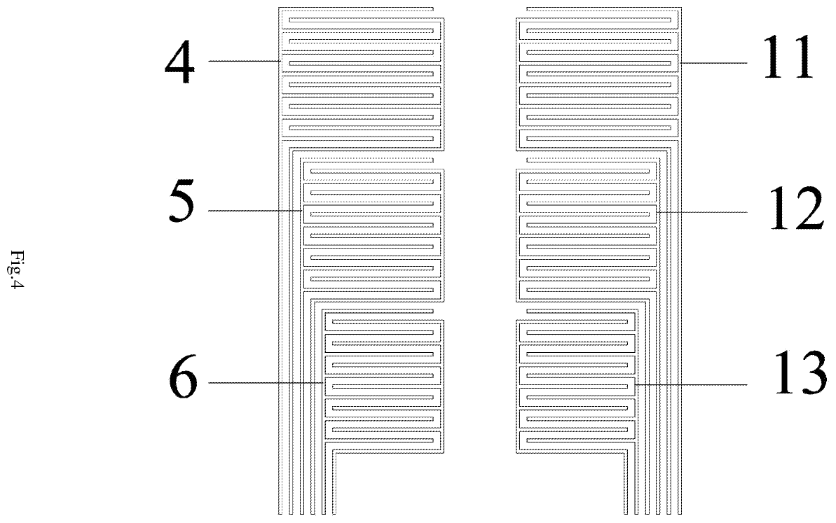

Referring to FIG. 1, FIG. 2, FIG. 3 and FIG. 4, in which FIG. 1 is a top view of a specific embodiment of a capacitive sensor according to the present disclosure. FIG. 2 is a left view of a specific embodiment of a capacitive sensor according to the present disclosure. FIG. 3 is a schematic diagram of a specific embodiment of a heating electrode in a capacitive sensor according to the present disclosure. FIG. 4 is a schematic diagram of a specific embodiment of a differential positive-negative electrode pair in a capacitive sensor according to the present disclosure. A capacitive sensor comprises a substrate 1, a heating electrode 2, a first insulating layer 3, differential positive-negative electrode pair, a functional material layer and a second insulating layer 10. The differential positive-negative electrode pair comprises a first positive-negative electrode pair and a second positive-negative electrode pair. In the embodiment, three differential positive-negative electrode pairs are comprised, wherein the first positive-negative electrode pair is shown as 4, 5 and 6 in FIG. 4, and the corresponding second positive-negative electrode pair is shown as 11, 12 and 13 in FIG. 4. The heating electrode 2 and the first insulating layer 3 constitute a temperature compensation layer, and are sequentially disposed on the substrate 1 as shown in FIG. 2. The differential positive-negative electrode pair are disposed on the first insulating layer 3, and the functional material layer is disposed above the first positive-negative electrode pair of the differential positive-negative electrode pair. As shown in FIG. 2, corresponding to the three differential positive-negative electrode pairs, the functional material layer is disposed on three positions (as 7, 8 and 9 in FIG. 2) of the first positive-negative electrode pair (as 4, 5 and 6 in the FIG. 2). The second insulating layer 10 is disposed above the first positive-negative electrode pair. The functional material layer not only needs to have a small reaction time and a relatively large change in dielectric constant for a physical quantity detected by the capacitive sensor, but also needs to have a high degree of recovery.

According to the present disclosure, the temperature compensation layer is prepared on the substrate, so that the temperature compensation of the capacitive sensor can be realized, and the capacitive sensor can test at a constant temperature and can work at a low temperature. The capacitive sensor of the present disclosure integrates the first positive-negative electrode pair provided with a functional material layer and the second positive-negative electrode pair not provided with a functional material layer to carry out differential sensing measurement, thereby eliminating reactions of the substrate, the heating electrode, the first insulating layer and the like to the functional material layer, which in turn improves the accuracy of the capacitive sensor. In addition, the capacitive sensor has the advantages of simple preparation process, low operating environment requirement and high sheeting rate, can be prepared in large quantities, and saves a large amount of manpower, material and financial resources.

Referring to FIG. 1 and FIG. 2 for a further improvement of the technical solution. In the embodiment, the substrate is a flexible transparent substrate, and the flexible transparent substrate has a thickness of 50 μm to 125 μm. Referring to FIG. 3, the heating electrode 2 is an annular electrode having a thickness of 5 μm to 15 μm and an annular pitch of 30 μm to 50 μm. The capacitive sensor of the present disclosure electroplates metal protection layer on the annular electrode, and a surface of the annular electrode electroplated with the metal protection layer is not only flat and smooth, but also protects the annular electrode from corrosion, and the annular electrode increases a length of the electrode by a curved structure, thus increasing a resistor of the electrode within an effective area, thereby increasing the heat generation of the resistor and implementing a function of providing heat to the sensor (i.e., the functional material layer) above the first insulating layer. The first insulating layer 3 is a transparent insulating layer film, which has good thermal conductivity, a thermal conductivity greater than 2 W/mK, and a high dielectric constant, does not have a great reaction to the functional material layer, and has a thickness of 14 μm to 50 μm. The insulating layer 3 is a Parylene series coating material. The second insulating layer 10 is also a transparent insulating layer film. As an insulating protection layer of the capacitive sensor, the second insulating layer 10 needs to be a gas-permeable impervious film with a high dielectric constant, and does not have a great reaction on the functional material layer. The transparent insulating layer film can isolate large molecules such as dust and water droplets in the atmospheric environment, and enables the gas analyte (when the capacitive sensor is a gas sensor) to penetrate through the second insulating layer film and enter the functional material layer. Moreover, the transparent insulating layer film in the surface layer can protect an underlying structure thereof from damage when the capacitive sensor is subjected to slight physical damage. The second insulating layer 10 needs to have a moderate thickness, and too thick will reduce an amount of analytical gases entering the functional material layer, thereby reducing the sensitivity of the capacitive sensor, while too thin cannot well play the functions as an insulating protective layer. Therefore, in the present embodiment, the second insulating layer 10 has a thickness of 0.5 μm to 1.5 μm. The second insulating layer 10 may be selected from AF or Cytop series coating materials.

As a further improvement of the technical solution, referring to FIG. 4, both the first positive-negative electrode pair (4, 5, and 6 in FIG. 4) and the second positive-negative electrode pair (11, 12, and 13 in FIG. 4) are interdigitated positive-negative electrode pair. The interdigitated positive-negative electrode pair has a thickness of 5 μm to 10 μm, and the distance between electrodes of the interdigitated positive-negative electrode pair (between the positive and negative electrodes) ranges from 40 μm to 100 μm. Designing the positive-negative electrode pair into the interdigitated positive-negative electrode pair have the following benefits.

1. The functional material layer (as a dielectric layer) can be prepared simply and conveniently.

2. The functional material layer can be fully exposed to a test environment (large contact surface and more accurate sensing).

3. The functional material layer can be made into a multi-layer structure as needed, and the thickness of the functional material layer is adjustable.

As a further improvement of the technical solution, the functional material layer in the embodiment is a moisture-sensitive functional material layer, an ammonia-sensitive functional material layer, or a carbon monoxide-sensitive functional material layer. The functional material layer has a thickness of 1 μm to 3 μm. In the present disclosure, the three functional material layers mentioned above are selected to form a gas sensor, and then the capacitive sensor of the present disclosure is capable of detecting a relative humidity value as well as a content and a change of ammonia gas and carbon monoxide in the environment. The present disclosure integrates a plurality of capacitive sensors that sense ambient gases on the flexible transparent substrate, so that the capacitive sensor can be compatible with wearable electronic devices.

Further, the gas sensors are all based on capacitance detection, and positive and negative electrodes of the interdigitated positive-negative electrode pair respectively serve as positive and negative electrodes of the capacitor. Since three different functional material layers respectively produce physical or chemical reactions to humidity, ammonia, and carbon monoxide in the atmospheric environment, when the contents of humidity (water vapor, gas), ammonia, and carbon monoxide in the atmospheric environment are changed, the dielectric constant and volume of the functional material layer will be changed, thereby causing a change in the capacitance of the capacitive sensor. The capacitive sensor is connected to the differential positive-negative electrode pair through a weak capacitance acquisition board to acquire the capacitance corresponding to the functional material layer in the environment with different analyte contents. In turn, the values of the humidity, ammonia, and carbon monoxide in the corresponding atmospheric environment can be obtained from the collected capacitance values. In fact, other factors such as the substrate, the heating electrode, the first insulating layer and the like will have an equivalent capacitive noise effect on the capacitance. Therefore, according to the present disclosure, a capacitance change value acquired in the first positive-negative electrode pair provided with the functional material layer is subtracted from a capacitance change value acquired in the second positive-negative electrode pair not provided with the functional material layer, which removes the influence of other factors such as the substrate, the heating electrode, the first insulating layer and the like on the capacitance noise, so that the sensing accuracy of the gas sensor is improved.

As a further improvement of the technical solution, the moisture-sensitive functional material layer is prepared by mixing cellulose acetate butyrate and ethyl acetate according to a mass ratio of 1:11. The ammonia-sensitive functional material layer is a solution of a nanoparticle material such as polyaniline, polythiophene or polypyrrole. The carbon monoxide-sensitive functional material layer is made of a carbon nanotube or a mixture of the carbon nanotube and other polymers.

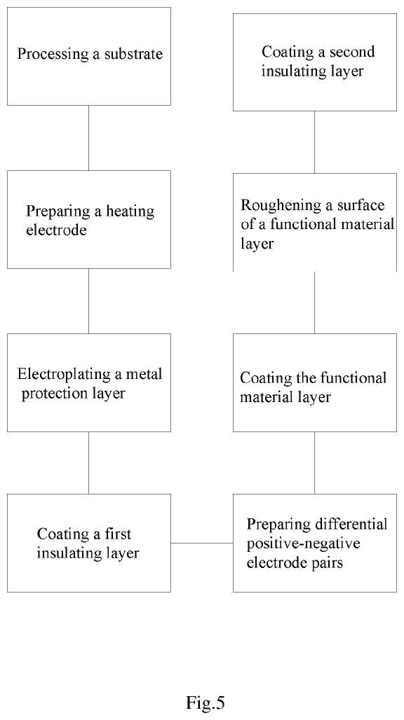

Referring FIG. 5, which is a flow chart of a specific embodiment of a preparation method for a capacitive sensor according to the present disclosure. Based on the above capacitive sensor, the present disclosure also provides a preparation method for a capacitive sensor, comprising the following steps:

Processing a substrate: a flexible transparent substrate is selected as the substrate, and the flexible transparent substrate is washed with water, then washed again with alcohol, a surface of the flexible transparent substrate is blown off with nitrogen, and then the flexible transparent substrate is immersed in acetone for several minutes, and then taken out and purged with nitrogen till the substrate has no impurity or dust; then plasma etching is performed on the flexible transparent substrate subjected to the above-mentioned processing to roughen the surface of the flexible substrate; and then the flexible transparent substrate is heated and baked. In the embodiment, a heating temperature is selected to be 150 degree Celsius.

Preparing a heating electrode: an annular electrode is selected as the heating electrode, a conducting material (i.e., electrode material) is formed into an annular electrode structure by performing inkjet printing, screen printing on the flexible transparent substrate subjected to the above-mentioned processing, and baked; in the embodiment, a heating temperature is selected to be 120 degree Celsius. In case of using the same electrode material, an annular pitch of the heating electrode is closely related to a temperature compensation performance of the entire capacitive sensor; if the annular pitch is too large, a length of a resistor arranged in the same area is insufficient, and thus, a corresponding temperature cannot be compensated; in the embodiment, the annular electrode has a thickness of 5 μm to 15 μm and a pitch of 30 μm to 50 μm.

Electroplating a metal protection layer: a metal protection layer is electroplated on a surface of the annular electrode prepared above and baked again. In this embodiment, a heating temperature is selected to be 120 degrees Celsius. The surface of the annular electrode electroplated with the metal protection layer is not only flat and smooth, but also protects the annular electrode from corrosion, and the annular electrode increases a length of the electrode by a curved structure, thus increasing a resistor of the electrode within an effective area, thereby increasing the heat generation of the resistor and implementing a function of providing heat to the sensor (i.e., the functional material layer) above the first insulating layer with excellent thermal conductivity.

Coating a first insulating layer: the first insulating layer (the first insulating layer is a transparent insulating layer film with excellent thermal conductivity) is prepared by a process such as screen printing, slit coating or inkjet printing on a region above the annular electrode electroplated with the metal protection layer, and cured by heating, wherein the heating is intended to cure and level the first insulating layer. In the embodiment, the heating temperature is selected to be 110 degrees Celsius, and the first insulating layer has a thickness of 14 μm to 50 μm. The function of the transparent insulating layer film with excellent thermal conductivity is to uniformly disperse the heat generated by the annular electrode on the functional material layer, and the transparent insulating layer film with excellent thermal conductivity cannot have a great influence on the sensing performance of the capacitive sensor (the first insulating layer has a high dielectric constant, and physical and chemical properties thereof do not change with changes in the humidity, ammonia, and carbon monoxide in the atmospheric environment, and the thermal conductivity is greater than 2 W/mK).

Preparing differential positive-negative electrode pair: interdigitated positive-negative electrode pairs (i.e., the differential positive-negative electrode pair) are formed by inkjet printing, screen printing or slit coating on the first insulating layer with excellent thermal conductivity, and baked. In the embodiment, the heating temperature is selected to be 110 degrees Celsius, the electrode has a thickness of 5 μm to 10 μm, and a pitch between the electrodes ranges from 40 μm to 100 μm. Since the amounts of gases to be detected in the environment are different, sensor sensitivities for detecting different gases sensors are different. For this case, the sensitivity of the capacitive sensor can be changed by adjusting the pitch between the electrodes and the thickness of the electrode. Moreover, for the differential positive-negative electrode pair, the first positive-negative electrode pair and the second positive-negative electrode pair are required to have the same parameter, that is, the two positive-negative electrode pairs are completely identical.

Coating a functional material layer: the functional material layer is coated on one of the differential positive-negative electrode pair only. In the present disclosure, the first positive-negative electrode pair is selected to be coated. A film having a uniform thickness of 1 μm to 3 μm is coated on the first positive-negative electrode pair by screen printing, inkjet printing or slit coating, and then cured by heating to obtain the functional material layer; the functional material layer comprises a moisture-sensitive functional material layer, an ammonia-sensitive functional material layer, or a carbon monoxide-sensitive functional material layer. In the present disclosure, the above three functional material layers are simultaneously selected.

Roughening a surface of the functional material layer: plasma etching is performed on the surface of the functional material layer to roughen the surface of the functional material layer, wherein plasma etching parameters are determined according to the functional material layer and the second insulating layer, then the surface of the functional material layer is modified to increase a roughness of the surface of the functional material layer, so that other materials are more easily coated on the modified surface of the functional material layer, which is convenient for coating a second insulating layer subsequently.

Coating the second insulation layer: a transparent insulating layer film (i.e., the second insulating layer) is prepared by a process such as screen printing, slit coating or inkjet printing in a region above the roughened functional material layer, and is cured by heating. In the embodiment, the heating temperature is selected to be 120 degrees Celsius, and the second insulating layer has a thickness of 0.5 μm to 1.5 μm. One purpose of curing is to make the functional material layer flat and smooth, and the other purpose of curing is to stabilize the structure of the second insulating layer. The role of the second insulating layer is to prevent other gases in the atmosphere from affecting the performance of the capacitive sensor and protecting the functional material layer from damage.

Further, in the present disclosure, the moisture sensitive functional material layer is prepared by mixing cellulose acetate butyrate and ethyl acetate according to a mass ratio of 1:11.

Preparing an ammonia-sensitive functional material layer: 0.6 ml of distilled aniline, 3.4 g of dodecylbenzenesulfonic acid, and 0.36 g of ammonium persulfate are added to 40 ml of deionized water and stirred for 2.5 h until a viscous solution is formed, and then the viscous solution can be coated on the sensor by a printing process. In conclusion, the solution formed of polyaniline nanoparticles is coated on the sensor by a printing process. The polyaniline nanoparticles can be replaced by nanoparticle materials such as polyaniline, polythiophene or polyp yrrole.

Preparing a carbon monoxide-sensitive functional material layer: 1 ml of carbon nanotube dispersion is added to 9 ml of ultrapure water, and ultrasonically dispersed for 30 minutes with an ultrasonic cleaning device, then 10 mg of platinum powder is added to the ultrasonicated sample, and ultrasonically dispersed for 30 minutes with the ultrasonic cleaning device continuously. Then, the mixture can be coated on the sensor by a printing process. The carbon nanotubes can also be replaced by materials mixed with carbon nanotubes and other polymers.

The present disclosure can be applied to other capacitive sensors, such as a capacitive liquid level sensor, etc.

The foregoing describes the preferred embodiments of the present disclosure in detail, but the present disclosure is not limited to the embodiments, those skilled in the art can make various equal deformations or replacements without departing from the spirit of the present disclosure, and these equal deformations or replacements shall all fall within the scope protected by the claims of the present disclosure.

1. A capacitive sensor comprising:
a substrate;
a differential positive-negative electrode pair disposed on the substrate, wherein the differential positive-negative electrode pair comprises a first positive-negative electrode pair and a second positive-negative electrode pair; and
a functional material layer disposed on the first positive-negative electrode pair.

2. The capacitive sensor of claim 1, wherein a temperature compensation layer is disposed between the substrate and the differential positive-negative electrode pair.

3. The capacitive sensor of claim 2, wherein the temperature compensation layer comprises a heating electrode disposed above the substrate and a first insulating layer covered above the heating electrode.

4. The capacitive sensor of claim 1, wherein the capacitive sensor further comprises a second insulating layer covered above the first positive-negative electrode pair.

5. The capacitive sensor of claim 1, wherein both the first positive-negative electrode pair and the second positive-negative electrode pair are interdigitated positive-negative electrode pair.

6. The capacitive sensor of claim 1, wherein the functional material layer is a moisture-sensitive functional material layer, an ammonia-sensitive functional material layer, or a carbon monoxide-sensitive functional material layer.

7. The capacitive sensor of claim 1, wherein the functional material layer has a thickness of 1 μm to 3 μm.

8. A preparation method for a capacitive sensor, comprising:
cleaning a substrate and drying the substrate to impurity-free;
preparing differential positive-negative electrode pair on the substrate, the differential positive-negative electrode pair comprises a first positive-negative electrode pair and a second positive-negative electrode pair; and
preparing a functional material layer on the first positive-negative electrode pair.

9. The preparation method for a capacitive sensor of claim 8, wherein a functional material is coated on the first positive-negative electrode pair by screen printing, slit coating or inkjet printing to prepare the functional material layer.

10. The preparation method for a capacitive sensor of claim 8, wherein a conducting material is coated on the substrate by screen printing, slit coating or inkjet printing to prepare the differential positive-negative electrode pair.

11. The preparation method for a capacitive sensor of claim 8, wherein both the first positive-negative electrode pair and the second positive-negative electrode pair are interdigitated positive-negative electrode pair.

12. The preparation method for a capacitive sensor of claim 8, wherein the functional material layer is a moisture-sensitive functional material layer, an ammonia-sensitive functional material layer or a carbon monoxide-sensitive functional material layer.

13. The preparation method for a capacitive sensor of claim 8, wherein the functional material layer has a thickness of 1 μm to 3 μm.

14. The capacitive sensor of claim 2, wherein both the first positive-negative electrode pair and the second positive-negative electrode pair are interdigitated positive-negative electrode pair.

15. The capacitive sensor of claim 3, wherein both the first positive-negative electrode pair and the second positive-negative electrode pair are interdigitated positive-negative electrode pair.

16. The capacitive sensor of claim 4, wherein both the first positive-negative electrode pair and the second positive-negative electrode pair are interdigitated positive-negative electrode pair.

17. The preparation method for a capacitive sensor of claim 9, wherein both the first positive-negative electrode pair and the second positive-negative electrode pair are interdigitated positive-negative electrode pair.

18. The preparation method for a capacitive sensor of claim 10, wherein both the first positive-negative electrode pair and the second positive-negative electrode pair are interdigitated positive-negative electrode pair.

19. The preparation method for a capacitive sensor of claim 9, wherein the functional material layer is a moisture-sensitive functional material layer, an ammonia-sensitive functional material layer or a carbon monoxide-sensitive functional material layer.

20. The preparation method for a capacitive sensor of claim 10, wherein the functional material layer is a moisture-sensitive functional material layer, an ammonia-sensitive functional material layer or a carbon monoxide-sensitive functional material layer.
